(19) United States
(12) Patent Application Publication
(10) Pub. No.: US 2003/0016417 A1
(43) Pub. Date: Jan. 23, 2003

(54) Wireless pointing and remote-controlling device for briefing

(76) Inventor: Cruise Lee, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/906,042

(22) Filed: Jul. 17, 2001

(51) Int. Cl. H04B 10/00

(52) U.S. Cl. 359/142; 359/143

(57) ABSTRACT

A wireless pointing and remote-controlling device for briefing comprises: a device casing, a receiver, and a power supply, wherein signals generated from a first or a second function-key set or an optical sensor, all disposed on the device casing, are transmitted by a wireless transmission unit set in the device casing to a computer via a wireless receiving unit of the receiver and an interface circuit connected with the wireless receiving unit. An operator is allowed to move freely within the scope reachable by the wireless transmission unit and operate the function-key sets and the optical sensor to control a pointer movable on the screen of a projector irrespective of orientation. Moreover, when the device casing of this invention is placed flatly and reversely on a pad, it can serve for a generic optical mouse.

### FIELD OF THE INVENTION

This invention relates to pointing and remote-controlling devices for briefing, more particularly, it relates to a wireless pointing and remote-controlling device for briefing, which generates signals to reach and control a computer pointer through wireless transmission.

### BACKGROUND OF THE INVENTION

The application fields and aspects of computer are widened and diversified day by day, from the data processing to a conference briefing, etc.

A conventional briefing pointer is usually a cord-connecting pointer constrained by length of transmission line, in which a user has to control a computer for page-scrolling otherwise that would bring inconvenience in briefing operation to some extent whatsoever. An infrared-ray controlled laser pointer, which is constrained both in orientation and range, doesn't help much to the conference briefing.

Moreover, a conventional wireless pointing device for briefing, such as the “pointing mouse for briefing” of Taiwan patent No. 320303 (abbrev. as “the cited patent” hereinafter), is characterized in structure that a laser pointer unit comprising a laser pointing circuit, a laser emitter, and a control switch is installed in the main body of the mouse, wherein the laser pointing circuit is controlled by the control switch and the laser emitter is employed for emitting laser pointing beams.

In summarizing abovesaid conventional pointing devices for briefing, it may be concluded that all of them are either single laser pointers or laser pointers installed on mice for merely pointing a briefing's content, incapable of controlling the mice meanwhile.

In view of the abovesaid imperfection, the inventor is benefited with years of experience in related field to have an improved mechanism of this invention developed and presented.

### SUMMARY OF THE INVENTION

The primary object of this invention is to provide a wireless pointing and remote-controlling device for briefing, which is supposed to transmit signals generated from a function-key set or an optical sensor to a wireless receiving unit of a receiver and communicate with a computer via an interface circuit connected to the wireless receiving unit merely through operation of a device casing of this invention to remote control a projector's screen pointer and thereby control a mouse pointer of computer accordingly irrespective of an operator's orientation.

Another object of this invention is to provide a wireless pointing and remote-controlling device for briefing, wherein if an optical sensor of device casing is placed flatly on a pad for operation, an associated switching switch or an automatic gravity-sensing switch will invert the signals of a wireless transmission unit so that this invention would become an optical mouse communicable with a computer.

Yet another object of this invention is to provide a wireless pointing and remote-controlling device for briefing, which may cooperate with a conventional laser-guiding device for aiding a briefing operation.

In order to realize abovesaid objects, the wireless pointing and remote-controlling device for briefing of this invention comprises:

a device casing comprising a wireless transmission unit, a first and a second function-key set, and an optical sensor, wherein both the first and the second function-key sets further comprise a plurality of function keys respectively;

a receiver having a wireless receiving unit, which is connected with an interface circuit; and

a power supply located in the device casing and controlled by a power switch for supplying power to various devices.

In operation, signals generated from either function-key set or the optical sensor are transmitted by the wireless transmission unit to the wireless receiving unit of the receiver, then relayed to a computer through an interface circuit connected with the wireless receiving unit. A laser-guiding device may be fitted on an end face of the device casing and ON/OFF controlled by a push-button switch for projecting laser beam. Moreover, if the optical sensor is placed flatly on a pad for operation, this invention may serve for a pure optical mouse, whose ON/OFF operation is controlled by a switching switch or an automatic gravity-sensing switch disposed on the device casing for switching and inverting the signals of the wireless transmission unit.

For more detailed information regarding advantages or features of this invention, at least an example of preferred embodiment will be elucidated below with reference to the annexed drawings.

### BRIEF DESCRIPTION OF THE DRAWINGS

FIG. 1 shows a wireless pointing and remote-controlling device for briefing of this invention in three dimensions.

FIG. 2 shows a first preferred embodiment of the wireless pointing and remote-controlling device for briefing.

FIG. 2(A) shows operation of the wireless pointing and remote-controlling device for briefing.

FIG. 3 shows a second preferred embodiment of the wireless pointing and remote-controlling device for briefing.

FIG. 4 shows a third preferred embodiment of the wireless pointing and remote-controlling device for briefing.

FIG. 5 shows a first operating state of an automatic gravity-sensing switch of the wireless pointing and remote-controlling device for briefing.

FIG. 6 shows a second operating state of an automatic gravity-sensing switch of the wireless pointing and remote-controlling device for briefing.

### DETAILED DESCRIPTION OF THE PREFERRED EMBODIMENT

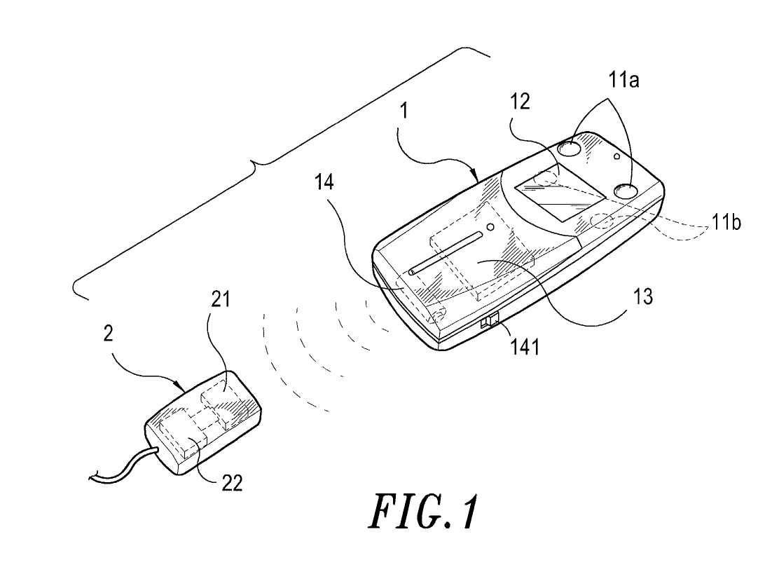

As indicated in FIG. 1—a wireless pointing and remote-controlling device for briefing in three dimensions—this invention is composed of a device casing 1, a receiver 2, and a power supply 14.

One face of the device casing 1 is provided with a first function-key set 11a and an optical sensor 12, and on the opposite face of the device casing 1 at corresponding positions, a second function-key set 11b is disposed, wherein both the first and the second function-key sets 11a, 11b comprise a plurality of function keys respectively. Meanwhile, a wireless transmission unit 13 is arranged in the device casing 1.

The receiver 2 contains a wireless receiving unit 21, which is connected with an interface circuit 22.

The power supply 14 is located in the device casing 1 and controlled by a power switch 141 for supplying power to various devices.

The signals generated from the first function-key set 11a, the second function-key set 11b, or the optical sensor 12 will be transmitted from the wireless transmission unit 13 in the device casing 1 to the wireless receiving unit 21 in the receiver 2, then is transferred outwardly via the interface circuit 22 connected with the wireless receiving unit 21.

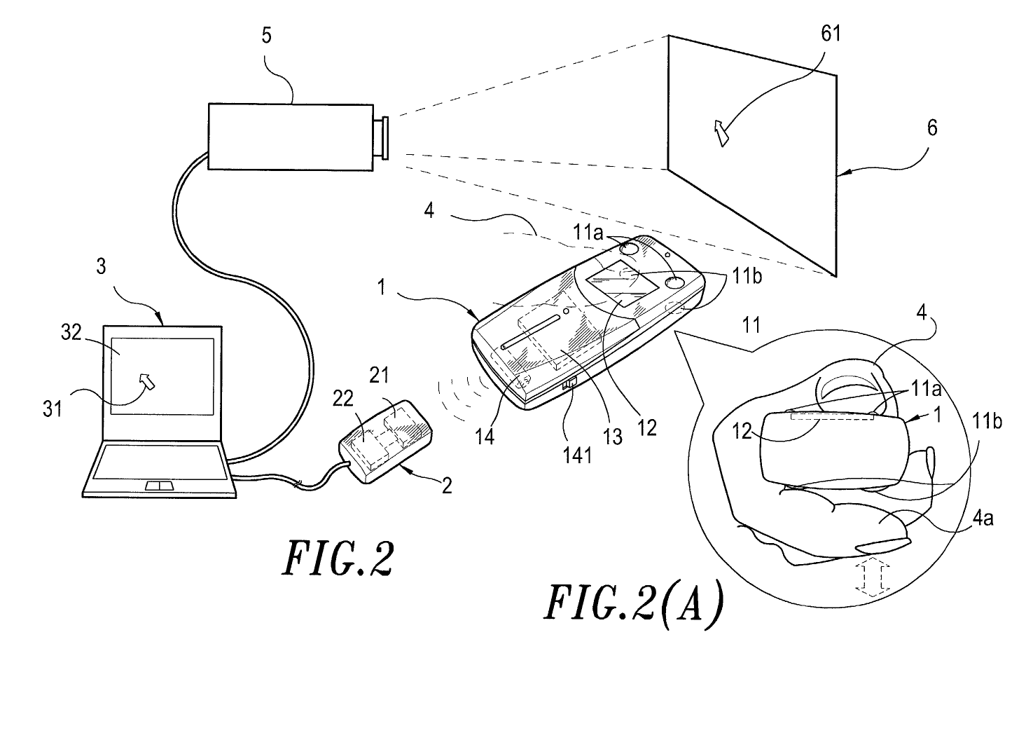

Referring to FIGS. 2 and 2(A)—a first preferred embodiment and operation respectively of the wireless pointing and remote-controlling device for briefing—a signal generated from the first or the second function-key sets 11a, 11b or the optical sensor 12 is transmitted to the wireless receiving unit 21 of the receiver 2 via the wireless transmission unit 13 located in the device casing 1, then to a computer 3 through the interface circuit 22 connected with the wireless receiving unit 21. An operator may rest and slide his/her thumb 4 on the optical sensor 12 to thereby create a positional signal for control of a pointer 61 on a projection screen 6 of a projector 5 which is in connection with the computer 3 through control of a computer's pointer 31 without needing observation on a computer screen 32 when operating. Meanwhile, the operator may use his/her rest fingers 4a to control the first and the second function-key sets 11a, 11b for execution of commands or operation of hot keys (such as fast opening or page scrolling/jumping). Under the arrangements as shown in FIGS. 2 and 2(A), an interpreter (usually an operator concurrently) may stand and hold this invention to operate the computer 3 with ease.

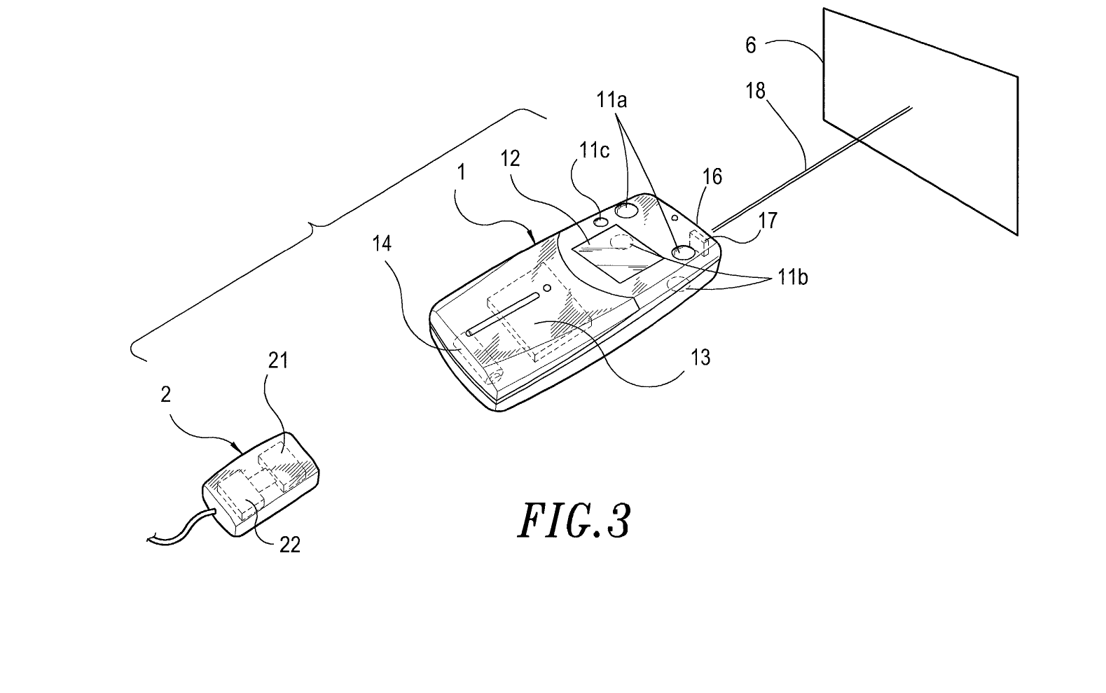

In FIG. 3—a second preferred embodiment of the wireless pointing and remote-controlling device for briefing—a conventional laser-guiding device 17 may be fitted on an end face 16 of the device casing 1 and ON/OFF controlled by a push-button switch 11c for projecting a laser beam 18 to be guided by the operator on the projection screen 6.

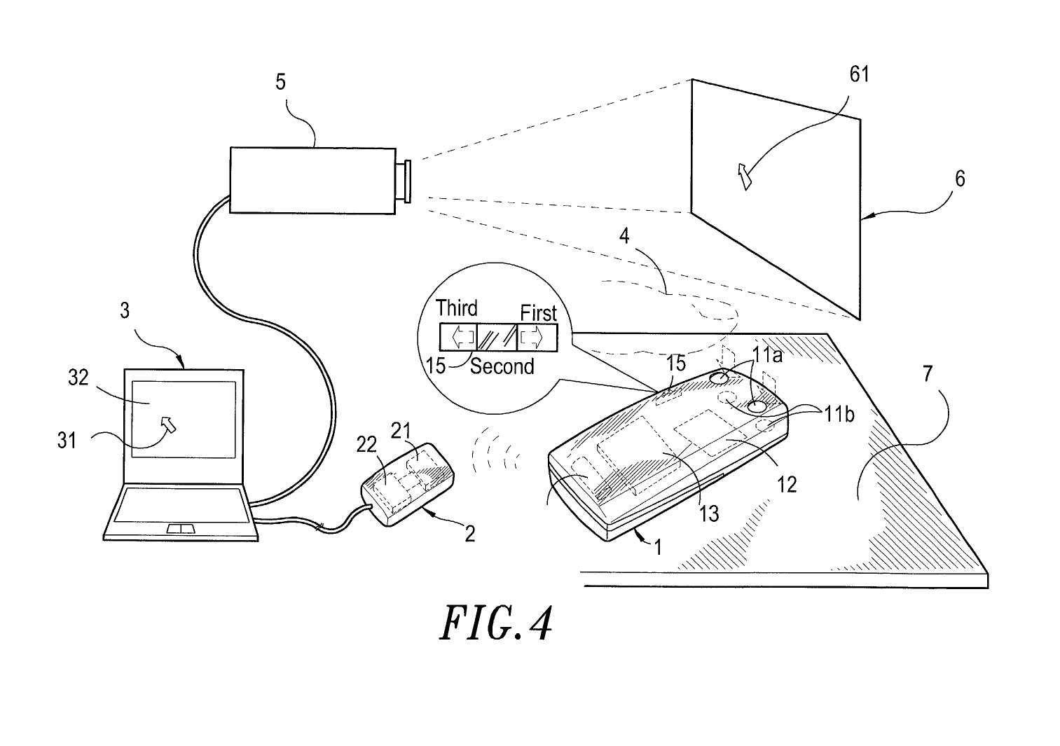

As indicated in a third preferred embodiment of the wireless pointing and remote-controlling device for briefing shown in FIG. 4, a selection switch 15 may be arranged on a lateral face of the device casing 1 for mode choice. When the switch 15 is effective at a first mode, it is exactly the first embodiment of this invention as described above which wouldn't be reiterated here.

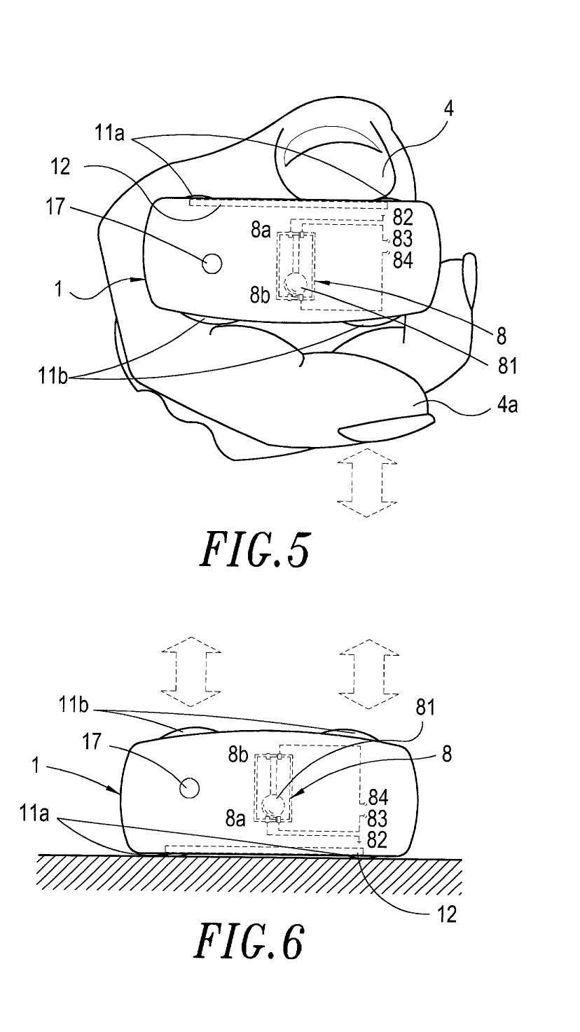

In the case the optical sensor 12 of the device casing 1 is placed flatly on a pad 7 for operation, the device casing 1 is considered a generic optical mouse, and at this moment, the switch 15 is effective at a second mode, which is to invert a signal of the wireless transmission unit 13 and provide an inversion output to be received by the wireless receiving unit 21 of the receiver 2. Now, if operation of the associated first and/or second function-key set 11a, 11b is desired, the operator is supposed to depress the first and/or the second function-key set 11a, 11b with his/her thumb 4 or fingers 4a to release an output signal of a function key, which is to be transmitted by the wireless transmission unit 13 located in the device casing 1 and received by the wireless receiving unit 21 of the receiver 2. The output signal is then relayed to the computer 3 via the interface circuit 22 connected with the wireless receiving unit 21, and by control of a pointer shown in the computer screen, the pointer 61 can be displayed on the projection screen 6 of the projector 5. When the switch 15 is switched to a third mode, the power supply is cut off and this invention is shut down. FIG. 5 and FIG. 6 show a first and a second operating state of an automatic gravity-sensing switch of the wireless pointing and remote-controlling device for briefing respectively. As described above, when the optical sensor 12 of the device casing 1 is placed flatly on the pad 7 for operation, the device casing 1 may serve for a generic optical mouse, and the switch 15 is required to switch the wireless transmission unit 13 for obtaining an inversion output signal that brings about inconvenience more or less. Therefore, an automatic gravity-sensing switch 8 is adopted in this invention for interchangeable applications between a briefing device and an optical mouse by gravity control of positions of a steel bead 81. As indicated in FIG. 5, when this invention serves as a briefing device, the steel bead 81 is descended to a first end 8b to touch both contacts 83, 84 or to a second end 8a to touch both contacts 82, 83 as shown in FIG. 6. Therefore, this invention is capable of converting different signals under different modes.

When compared with prior arts, the wireless pointing and remote controlling device for briefing of this invention is more advantageous in the following respects:

(1) The wireless remote control for briefing operation is indifferent to orientation of an operator.

(2) As this invention can serve as an optical mouse, it is convenient to people who are familiar with mouse operation.

(3) A conventional laser pointer may be added to this invention to aid a briefing operation.

(4) The pointer signals of a computer are controlled by an optical sensor of this invention, which can be held with a hand while fingers thereof are free to slide (its operation mode is something like a tangible control panel), and the control principle of this invention is in form of an optical induction that no pad or table would be needed, meanwhile, the operation accuracy won't be deteriorated because no dust is attached.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A wireless pointing and remote-controlling device for briefing, comprising:
a device casing having: a first function-key set and an optical sensor disposed on one lateral face thereof; a second function-key set disposed on the opposite other lateral face at positions corresponding to the first key set; and an inside wireless transmission unit;
a receiver having a wireless receiving unit, which is connected with an interface circuit; and
a power supply located in the device casing and controlled by a power switch; wherein
signals generated from the first or the second function-key set or the optical sensor by sliding fingers thereon are transmitted by the wireless transmission unit to a computer via the wireless receiving unit of the receiver and the interface circuit connected with the wireless receiving unit.

2. The wireless pointing and remote-controlling device for briefing according to claim 1, wherein an associated laser-guiding device is installed at an end face of the device casing and controlled by a push-button switch for ON/OFF operation.

3. The wireless pointing and remote-controlling device for briefing according to claim 1, wherein the optical sensor on the device casing is placed flatly on a pad to serve for a generic optical mouse.

4. The wireless pointing and remote-controlling device for briefing according to claim 1, wherein the first function-key set comprises a plurality of push buttons.

5. The wireless pointing and remote-controlling device for briefing according to claim 1, wherein the second function-key set comprises a plurality of push buttons.

6. The wireless pointing and remote-controlling device for briefing according to claim 3, wherein a switching switch is provided to the device casing for switching or inverting signals of the wireless transmission unit when the optical sensor on the device casing is placed flatly on a pad for operation.

7. The wireless pointing and remote-controlling device for briefing according to claim 4, wherein the switching switch is an automatic gravity-sensing switch.
